(19) United States
(12) Patent Application Publication
(10) Pub. No.: US 2016/0252179 A1
(43) Pub. Date: Sep. 1, 2016

(54) HYDRAULIC SYSTEM FOR TRANSMISSION ASSEMBLY

(71) Applicant: Caterpillar Inc., Peoria, IL (US)

(72) Inventor: Heath A. Toennies, Eureka, IL (US)

(73) Assignee: Caterpillar Inc., Peoria, IL (US)

(21) Appl. No.: 15/151,589

(22) Filed: May 11, 2016

(51) Int. Cl. F16H 61/4008; F15B 1/027; F16H 61/4035

(52) U.S. Cl. CPC F16H 61/4008; F16H 61/4035; F15B 1/027

(57) ABSTRACT

A hydraulic system for a transmission assembly includes a pump having a first and a second section to pressurize fluid to first and second pressure, respectively, and supply it to a clutch via a first supply line and to a variator via a second supply line, respectively. The system further includes an accumulator and a pressure relieving valve (PRV), both connected to first supply line for maintaining pressure in the first supply line. The system uses the PRV to maintain the second pressure by relieving oil from the second supply line or by reducing oil from the first supply line to the second supply line. The system further includes a first and second flow control valve. First valve restricts flow of fluid from the variator to the sump, and such restriction allows the fluid to flow towards the PRV for being supplied to the first supply line.

### TECHNICAL FIELD

The present disclosure relates to a transmission assembly and more particularly to a hydraulic system for the transmission assembly.

### BACKGROUND

Typically, a continuously variable transmission (CVT) includes a clutch assembly and a powertrain. A hydraulic system is coupled to the CVT to supply fluid, such as oil, wider pressure for facilitating operation of the clutch assembly and the powertrain. The hydraulic system includes a pump, such as a dual section fixed displacement pump, that draws fluid from a reservoir and supplies the fluid to two circuits in the hydraulic system. The two circuits include a high pressure circuit that supplies oil to control units of CVT and a low pressure circuit that supplies oil to a variator of the CVT. These two circuits require fluid to be supplied continuously at respective pressures for continuous operation of the CVT. However, in cases where pressure in the high pressure circuit falls below a threshold value, even momentarily, the clutch assembly and the powertrain may not receive fluid with the required pressure. Such instances may cause decrease in efficiency of the CVT and, also, deterioration of the CVT.

U.S. Pat. No. 7,401,465, hereinafter referred to as the '465 patent, describes a hydraulic system provided for an engine driven vehicle. The hydraulic system includes a high pressure engine driven pump for supplying pressurized fluid to a high pressure circuit via a first supply line. The hydraulic system also includes a low pressure engine driven pump for supplying low pressure fluid to a low pressure circuit via a second supply line. The hydraulic system also includes a pressure responsive relief valve. The pressure responsive relief valve has a sensing port connected to the first supply line, an inlet connected to the first supply line, and an outlet connected to the second circuit via the second supply line. The pressure responsive relief valve opens when demand of the high pressure circuit is satisfied. A cut-off valve controls communication between the high pressure circuit and a reservoir, and a control unit controls the cut-off valve as a function of operation of the high pressure circuit. The '465 patent fails to address pressure demand in the high pressure circuit.

### SUMMARY OF THE DISCLOSURE

In one aspect of the present disclosure, a hydraulic system for a transmission assembly of a machine is provided. The transmission assembly includes a clutch and a variator. Further, the hydraulic system includes a hydraulic power supply unit in fluid communication with a sump. The hydraulic power supply unit includes a first section adapted to pressurize the fluid to a first pressure and supply the pressurized fluid to the clutch via a first supply line. The hydraulic power supply unit further includes a second section adapted to pressurize the fluid to a second pressure and supply the pressurized fluid to the variator via a second supply line. The second pressure is less than the first pressure. The hydraulic system further includes at least one accumulator in fluid communication with the first supply line. The at least one accumulator adapted to receive fluid from the first supply line, store the fluid at a predetermined accumulator pressure, and supply the pressurized fluid to the clutch via the first supply line, when pressure of the fluid in the first supply line is less than a first desired pressure of the first supply line. The first pressure of fluid in the first supply line is less than the predetermined accumulator pressure. The hydraulic system further includes a pressure relieving valve in fluid communication with the first supply line and the second supply line. The pressure relieving valve is adapted to maintain the first desired pressure in the first supply line by routing the pressurized fluid from the second supply line to the first supply line when pressure of the fluid in the accumulator is less than the predetermined accumulator pressure. The pressure relieving valve is further adapted to maintain a second desired pressure in the second supply line by routing the pressurized fluid from the first supply line to the second supply line when pressure of the fluid in the second supply line is less than the second desired pressured. The pressure relieving valve is further adapted to route fluid from at least one of the first supply line and the second supply line to the sump, until the first desired pressure and the second desired pressure in the first supply line and the second supply line, respectively, is achieved. The hydraulic system further includes a first flow control valve in fluid communication with an outlet of the variator. The first flow control valve is adapted to allow flow of the fluid from the variator to the sump. The first flow control valve is coupled to the first supply line via a first pressure sensing line to draw a pressure reference from the first supply line. The hydraulic system further includes a second flow control valve in fluid communication with the pressure relieving valve via a second pressure sensing line to draw a pressure reference from the pressure relieving valve. The second flow control valve is also in fluid communication with the first supply line via a third pressure sensing line to draw a pressure reference from the first supply line. The second flow control valve routes the fluid received from the pressure relieving valve to the sump when the first desired pressure in the first supply line is achieved. The first flow control valve restricts flow of fluid from the variator to the sump when the pressure in the first supply line is less than the first desired pressure. The restriction allows the fluid to flow towards the pressure relieving valve for being supplied to the first supply line to achieve the first desired pressure in the first supply line.

Other features and aspects of this disclosure will be apparent from the following description and the accompanying drawings.

### BRIEF DESCRIPTION OF THE DRAWINGS

FIG. 1 is a side view of an exemplary machine having a hydraulic system, according to an embodiment of the present disclosure;

FIG. 2A is a block diagram of the hydraulic system during normal operation condition of the machine;

FIG. 2B is a variant of the block diagram of FIG. 2A showing the hydraulic system during normal operation condition of the machine;

FIG. 2C is another variant of the block diagram of FIG. 2A showing the hydraulic system during normal operation condition of the machine;

FIG. 3 is a block diagram of the hydraulic system during low engine speed condition of the machine; and

FIG. 4 is a block diagram of the hydraulic system during the low engine speed of the machine and pressure demand condition in a first supply line of the hydraulic system.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

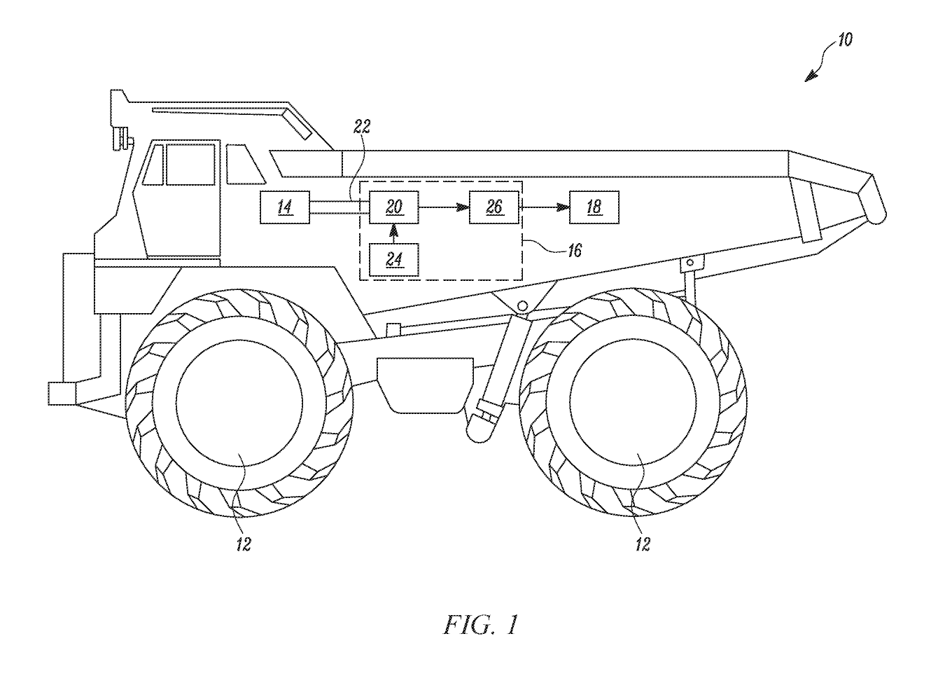

FIG. 1 illustrates a side view of an exemplary machine 10. The machine 10 is embodied as a large mining truck (LMT) for the purpose of illustration. Alternatively, the machine 10 may be embodied as, but not limited to, an articulated truck, an off-highway truck, an on-highway truck, a dump truck, a loader, an excavator, a backhoe loader, a wheel loader, a skid steer loader, a dozer, or a hydraulic mining shovel. The machine 10 includes a plurality of ground-engaging elements 12 for propelling the machine 10. In the illustrated embodiment, the ground-engaging elements 12 are wheels.

The machine 10 includes an engine 14, which may be embodied as a compression ignition engine, a spark-ignition engine, or any type of combustion engine known to one skilled in the art. The machine 10 further includes a hydraulic system 16 for supplying hydraulic power to various downstream components, such as a transmission assembly 18, of the machine 10. The hydraulic system 16 includes a hydraulic power supply system 20 coupled to the engine 14 via a drive 22. In an example, the drive 22 may be a shaft or a combination of the shaft and a gear train. Owing to such coupling, the engine 14 assists the hydraulic power supply system 20 to draw fluid, such as oil, from a sump 24 and supply the fluid to the transmission assembly 18 via a valve assembly 26. The hydraulic power supply system 20 is embodied as a pump that pumps the fluid from the sump 24. The pump may operate either on a rotary mechanism or a reciprocating mechanism. For the purpose of description, the hydraulic power supply system 20 is hereinafter referred to as the pump 20. Further, the transmission assembly 18 is coupled to the ground-engaging elements 12 for transmitting power from the engine 14 to the ground-engaging elements 12 and, thereby, allowing movement of the machine 10.

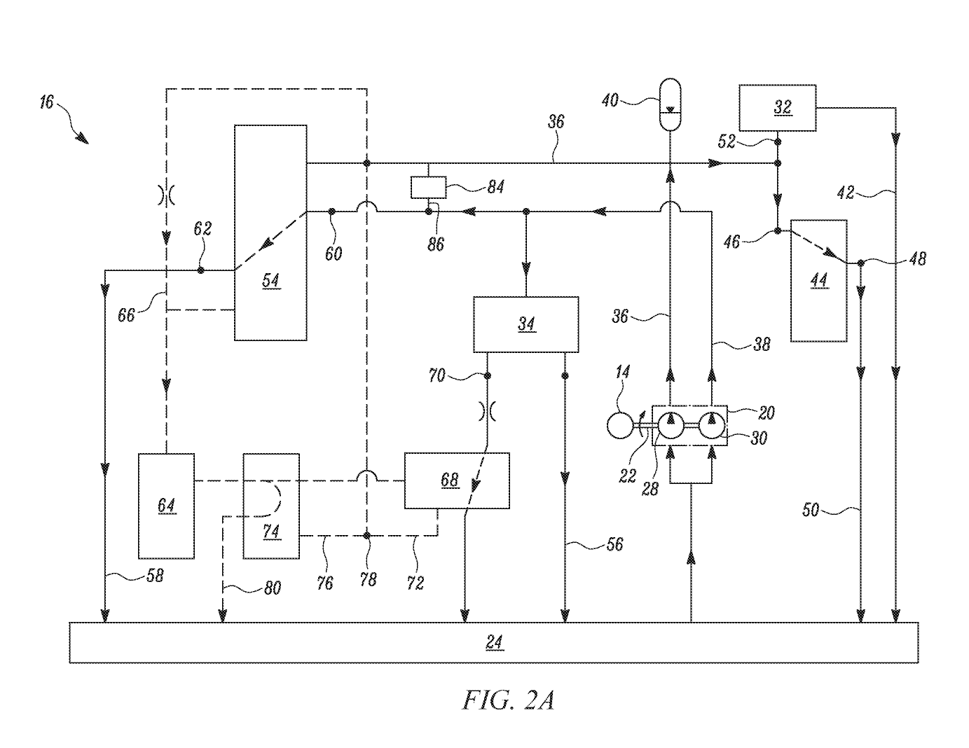

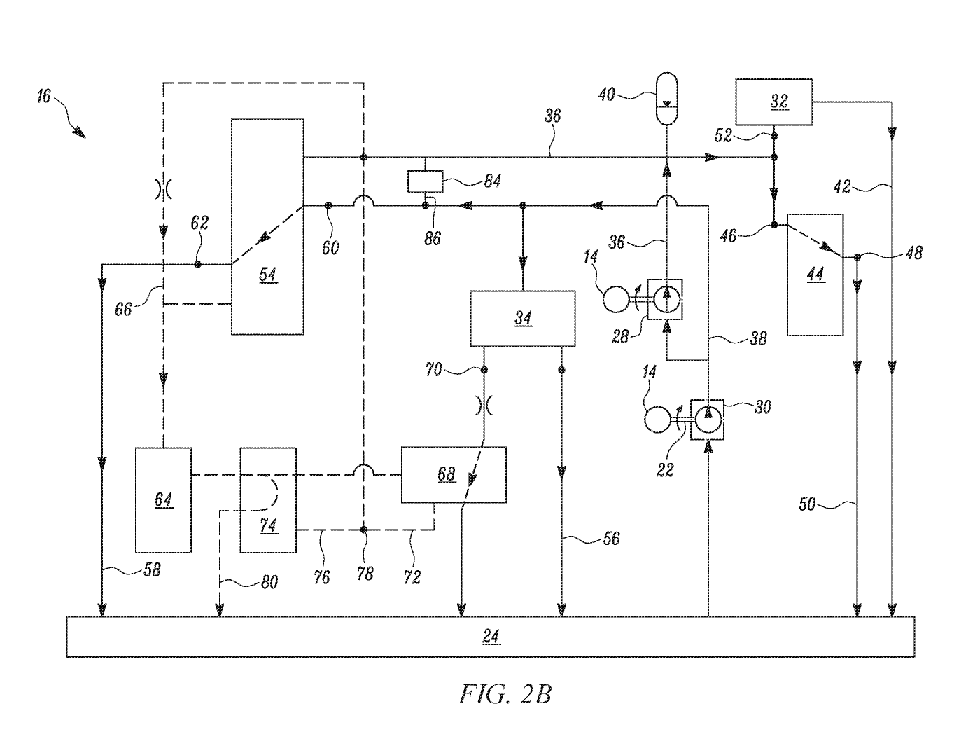

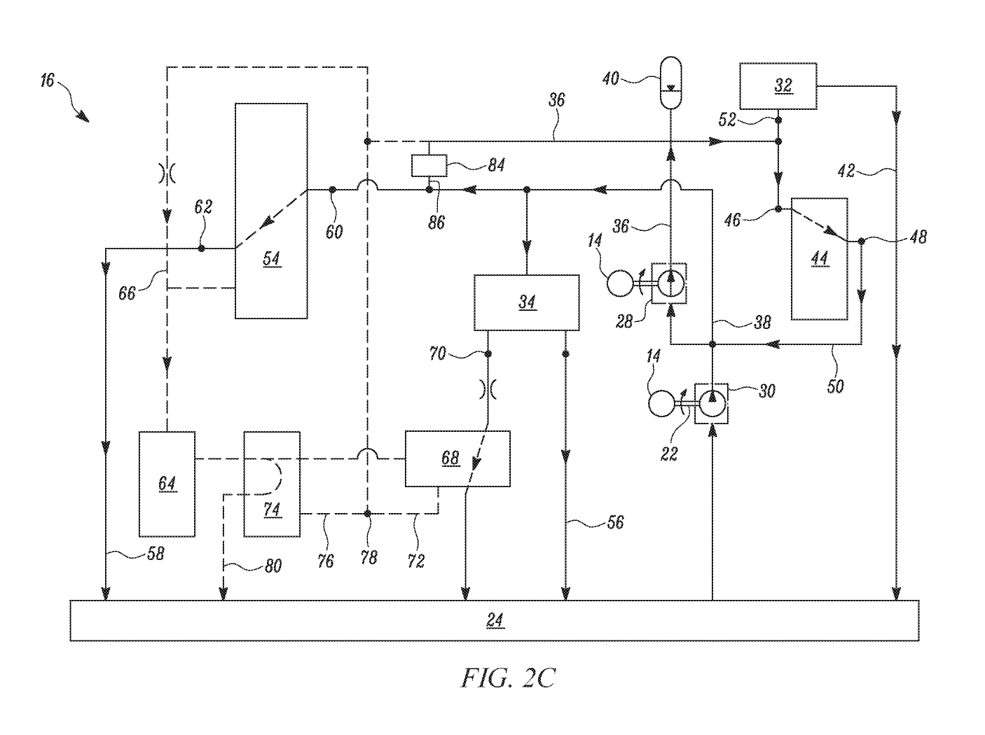

FIG. 2A illustrates a block diagram of the hydraulic system 16 during normal operation condition of the machine 10. In the illustrated embodiment, the pump 20 of the hydraulic system 16 includes a first section 28 and a second section 30. For example, the first section 28 and the second section 30 may be two individual volutes in housing of the pump 20. As described earlier, the pump 20 is coupled to the engine 14 via the drive 22. As such, the pump 20 operates at a rotational speed of the drive 22. The pump 20 is further disposed in fluid communication with the sump 24. In an example, the sump 24 may be an oil sump of predefined volume and adapted to store oil for purpose of lubricating components of the hydraulic system 16, the engine 14, the transmission assembly 18, and various other systems of the machine 10. The pump 20 draws the fluid from the sump 24. The fluid drawn by the pump 20 flows through each volute of the pump 20, thereby being pressured to respective pressures based on cross-section of the volutes. For instance, the first section 28 is adapted to pressurize the fluid to a first pressure ‘P1’ and the second section 30 is adapted to pressurize the fluid to a second pressure ‘P2’ that is less than the first pressure ‘P1’. Although the hydraulic system 16 herein includes a single pump 20 having the first section 28 and the second section 30 for pressurizing fluid to the first and the second pressures ‘P1’ and ‘P2’, respectively, it should be understood that such implementation is not limiting the description or the appended claims. Alternatively, the hydraulic system 16 may include two pumps, each pump for pressuring the fluid to the first and second pressures ‘P1’ and ‘P2’.

Further, as described earlier, the pump 20 supplies the fluid to the transmission assembly 18 that includes a clutch 32 and a variator 34. In one example, the transmission assembly 18 may be an automatic transmission system. In another example, the transmission assembly 18 may embody a continuously variable transmission (CVT) that includes variable speed hydraulic or electric drives disposed in opposed configuration for defining and adjusting an infinite number of gear ratios. The first section 28 of the pump 20 is adapted to supply the pressurized fluid to the clutch 32 via a first supply line 36. Likewise, the second section 30 of the pump 20 is adapted to supply the pressurized fluid to the variator 34 via a second supply line 38. The first supply line 36 and the second supply line 38 may be understood as passages or grooves formed in the hydraulic system 16 to allow flow of fluid from the pump 20 to the clutch 32 and the variator 34, respectively.

The hydraulic system 16 further includes an accumulator 40 that is in fluid communication with the first supply line 36. Accumulator 40 may be understood as a device deployed in the hydraulic system 16 to store energy, in form of hydraulic pressure, and smoothen any pulsation that may be generated in the hydraulic system 16. In particular, the accumulator 40 reduces shocks caused by rapid operation, or sudden start and stopping, of various components in the hydraulic system 16. In an example, the accumulator 40 may be one of a weight-loaded piston type accumulator, spring type accumulator, diaphragm or bladder type accumulator, and a hydro-pneumatic piston type accumulator, The accumulator 40 assists and aids in, not limited to, storing fluid at a predetermined accumulator pressure, maintaining desired pressure in the hydraulic system 16 in case of pressure drop in the hydraulic system 16, and dispensing the stored fluid at required pressure to overcome the pressure drop in the hydraulic system 16.

The accumulator 40 is adapted to be charged by the fluid flowing in the first supply 36 and associated with the first pressure ‘P1’. That is, the accumulator 40 is adapted to receive the fluid from the first supply line 36, as shown in FIG. 2A, and store the fluid at the predetermined accumulator pressure. Once the fluid is received therein, the accumulator 40 stores the fluid at a pressure based on volume available within the accumulator 40. This pressure at which the fluid is stored may be understood as the predetermined accumulator pressure.

The accumulator 40 is further adapted to supply the pressurized fluid, which is the fluid stored therein, to the clutch 32 via the first supply line 36 when pressure of the fluid in the first supply line 36 is less than a first desired pressure of the first supply line 36. The first desired pressure may be understood as the minimum pressure that needs to be maintained in the first supply line 36 for operating the clutch 32 and other downstream components associated with the clutch 32. Any additional fluid that is supplied to the clutch 32, or spent fluid from the clutch 32, flows to the sump 24 via a first discharge line 42, as shown in FIG. 24.

The hydraulic system 16 further includes a pressure regulating valve 44 in fluid communication with the first supply line 36. The pressure regulating valve 44 functions as a pressure regulator to maintain the first desired pressure in the first supply line 36. In cases where the pressure in the first supply line 36 increases beyond the first desired pressure, the pressure regulating valve 44 causes some amount of fluid from the first supply line 36 to be drained to the sump 24. A second discharge line 50 connects an outlet 48 of the pressure regulating valve 44 to the sump 24. Therefore, the fluid from the first supply line 36 is allowed to flow through the second discharge line 50 until the pressure in the first supply line 36 attains the first desired pressure. In addition, an inlet 46 of the pressure regulating valve 44 is connected to an inlet 52 of the clutch 32. As such, the pressure of the fluid that is supplied to the clutch 32 from the first supply line 36 is also regulated. It will be understood to a person skilled in the art that the pressure regulating valve 44 may include an adjustment mechanism, such as an adjustment screw, a solenoid, or pilot section, which aids in calibrating the pressure regulating valve 44 to the first desired pressure. For instance, the first desired pressure may be 32 bar and the pressure regulating valve 44 may drain the fluid from the first supply line 36 when the pressure in the first supply line 36 increases beyond 32 bar.

Further, as mentioned earlier, the pump 20 also supplies the fluid to the variator 34 via the second supply line 38. In order to maintain a second desired pressure in the second supply line 38, the hydraulic system 16 further includes a pressure reducing or pressure relieving valve 54, hereinafter referred to as pressure relieving valve 54, in fluid communication with the second supply line 38. The second desired pressure may be understood as the minimum pressure that needs to be maintained in the second supply line 38 to control operation of the variator 34. Alternatively, the second desired pressure may be understood as the pressure that needs to be supplied to the variator 34 to cool the variator 34, thereby regulating temperature of the variator 34. Any leakage from the variator 34 is routed to the sump 24 via a third discharge line 56, as shown in FIG. 2A.

Furthermore, the pressure relieving valve 54 is adapted to maintain the second desired pressure in the second supply line 38 by routing the pressurized fluid from the second supply line 38 to the sump 24 via a fourth discharge line 58, or by reducing supply of pressurized oil from the first supply line 36 to the second supply line 38. The pressure relieving valve 54 is adapted to be actuated when the pressure in the second supply line 38 increases beyond the second desired pressure. For example, the pressurized fluid is routed from an inlet 60 of the pressure relieving valve 54 to an outlet 62 of the pressure relieving valve 54 when the pressure in the second supply line 38 exceeds the second desired pressure.

The hydraulic system 16 further includes a pilot valve 64 in fluid communication with the pressure relieving valve 54. The pilot valve 64 is adapted to receive metered or pilot flow from the first supply line 36 via, a pilot flow line 66. The pilot flow may be understood as a small amount of fluid flow drained the first supply line 36. Pressure in the pilot flow line 66 regulates pressure setting of the pressure relieving valve 54 for the purpose of regulating pressure in the second supply line 38.

The hydraulic system 16 further includes a first flow control valve 68 in fluid communication with an outlet 70 of the variator 34. In an example, the first flow control valve 68 may be embodied as a spring loaded flow control valve with spool arrangement. It will be understood by one ordinary skilled in the art that a spool may be disposed in the first flow control valve 68 against a biasing force of a spring. Further, the first flow control valve 68 is coupled to the first supply line 36 via a first pressure sensing line 72 to draw a pressure reference from the first supply line 36. Configuration of the first flow control valve 68 may be selected based on the requirement in the hydraulic system 16. For instance, the biasing force of the spring of the first flow control valve 68 may be less than a force applied on the spring due to the pressure reference drawn from the first supply line 36. Owing to such difference in forces, the spring of the first flow control valve 68 is compressed, thereby causing the spool to move in a direction of compression of the spring. As such, the first flow control valve 68 is adapted to allow, therethrough, flow of fluid from the outlet 70 of the variator 34 to the sump 24, as shown in FIG. 2A.

A second flow control valve 74 is also deployed in the hydraulic system 16 to control flow of fluid from the pilot valve 64 to the sump 24 and to provide a pressure reference to the first flow control valve 68 based on pilot flow received by the pilot valve 64. In an example, like the first flow control valve 68, the second flow control valve 74 may also be embodied as a spring loaded flow control valve with spool arrangement. Further, the second flow control valve 74 is coupled to the first supply line 36 via a second pressure sensing line 76. The first pressure sensing line 72 and the second pressure sensing line 76 may be combined at node 78, so that the node 78 receives the pressure reference from the first supply line 36. Furthermore, the second flow control valve 74 is also coupled to the pilot valve 64 to receive the pilot flow from the pilot valve 64. The second flow control valve 74 is actuated similar to that of the first flow control valve 68. That is, when the first desired pressure is greater than the biasing force of the spring of the second flow control valve 74, the spring is compressed. Due to the compressed condition of the spring, the spool of the second flow control valve 74 may be moved towards the compressed spring, thereby allowing pilot flow therethrough. The pilot flow is subsequently relieved to the sump 24 by the second flow control valve 74 via a fifth discharge line 80.

During a normal operating condition of the machine 10, power generated from the engine 14 is transmitted to the pump 20, thereby causing the pump 20 to draw the fluid from the sump 24. The fluid thus drawn is pressurized in the first section 28 and the second section 30 of the pump 20, The pressurized fluid from the first section 28 is supplied to the clutch 32 via the first supply line 36 and to the variator 34 via the second supply line 38. During the supply of the fluid through the first supply line 36, the accumulator 40 is charged until the accumulator 40 has achieved the predetermined accumulator pressure. In cases where the pressure developed in the first supply line 36 is greater than the first desired pressure, the pressure regulating valve 44 routes excess fluid from the first supply line 36 to the sump 24. Similarly, when the pressure developed in the second supply line 38 is greater than the second desired pressure, the pressure relieving valve 54 routes the fluid from the second supply line 38 to the sump 24. Simultaneously, the pressurized fluid is supplied to the variator 34 for cooling the variator 34, and excess fluid supplied and spent fluid is routed to the sump 24, as described earlier. Accordingly, the required pressure demands in the first supply line 36 and the second supply line 38 are achieved.

It will be understood that the arrangement of various valves, supply lines, and drain lines illustrated and described with reference to FIG. 2A are for mere purpose of description of the present disclosure and in no way limit the scope of the present disclosure. Alternative layouts of the hydraulic system 16 may be derived by the person skilled in the art, albeit with few variations to the layout illustrated in FIG. 2A. Further, FIG. 2B and FIG. 2C illustrates two such variations made to the block diagram of FIG. 2A.

As mentioned earlier, the hydraulic system 16 may include two pumps, each pump for pressuring the fluid to the first and second pressures ‘P1’ and ‘P2’. Accordingly, with reference to FIG. 2B the first section 28 and the second section 30 of the pump 20 are illustrated as individual pumps, such as a first pump 28 and a second pump 30. The first pump 28 is supplied with fluid by the second pump 30 and driven by the engine 14. In an example, the first pump 28 may be connected in series with the second pump 30. FIG. 2C illustrates another variant of the block diagram of the hydraulic system 16 of FIG. 2A. In addition to the variation illustrated in FIG. 2B, the second discharge line 50 from the pressure regulating valve 44 may be connected to the second supply line 38, as shown in FIG. 2C.

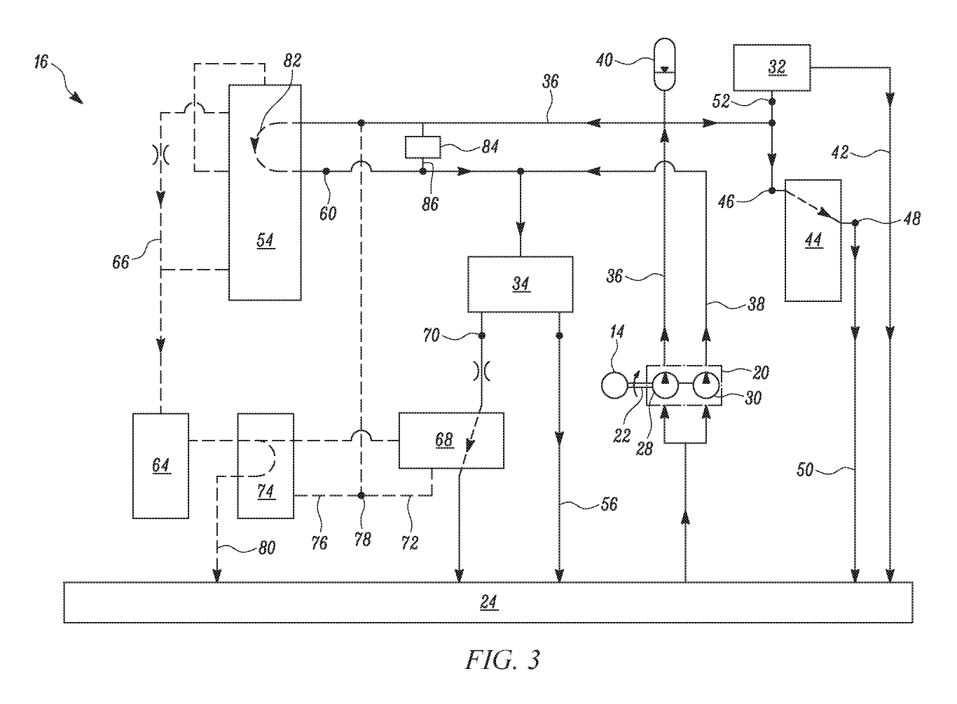

FIG. 3 illustrates a block diagram of the hydraulic system 16 during low engine speed condition of the machine 10. The engine 14 of the machine 10 transmits comparatively less speed, through the drive 22, to the pump 20. However, in such low speed conditions as well, the first desired pressure and the second desired pressure of the fluid needs to be maintained in the first supply line 36 and the second supply line 38, respectively, to maintain the clutch 32 and the variator 34 in operating condition. Owing to low pump speed, less quantity of fluid is drawn from the sump 24. As such, less amount of fluid is pressurized and supplied through the first supply line 36 and the second supply line 38. Therefore, such less amount of pressurized fluid may not aid in attaining the first desired pressure and the second desired pressure in the first supply line 36 and the second supply line 38, respectively. In such cases, the pressure developed in the first supply line 36 and the second supply line 38 is less than the first desired pressure and the second desired pressure, respectively.

Based on the pressure in the first supply line 36, the accumulator 40 is adapted to supply pressurized fluid to the first supply line 36, and thereby enabling the first supply line 36 to attain the first desired pressure. Further, the pressurized fluid is supplied to the clutch 32 via the first supply line 36. Any leakage of fluid or spent fluid from the clutch 32 is routed to the sump 24 via the first discharge line 42. Subsequently, if the pressure developed in the first supply line 36, due to supply of pressurized fluid from the accumulator 40, increases beyond the first desired pressure, the pressure regulating valve 44 routes the excess fluid from the first supply line 36 to the sump 24 via the second discharge line 50. Simultaneously, the pressure relieving valve 54 routes the pressurized fluid from the first supply line 36 to the second supply line 38 via an auxiliary flow path 82 provided therein, as shown in FIG. 3. Such supply of pressurized fluid from the first supply line 36 to the second supply line 38 aids in attaining the second desired pressure in the second supply line 38.

Further, the pressurized fluid is supplied to the variator 34 for cooling the variator 34. Excess fluid and leakage fluid from the variator 34 is routed to the sump 24 via the first flow control valve 68 and the third discharge line 56, respectively. Accordingly, the required pressure demands in the first supply line 36 and the second supply line 38 are achieved.

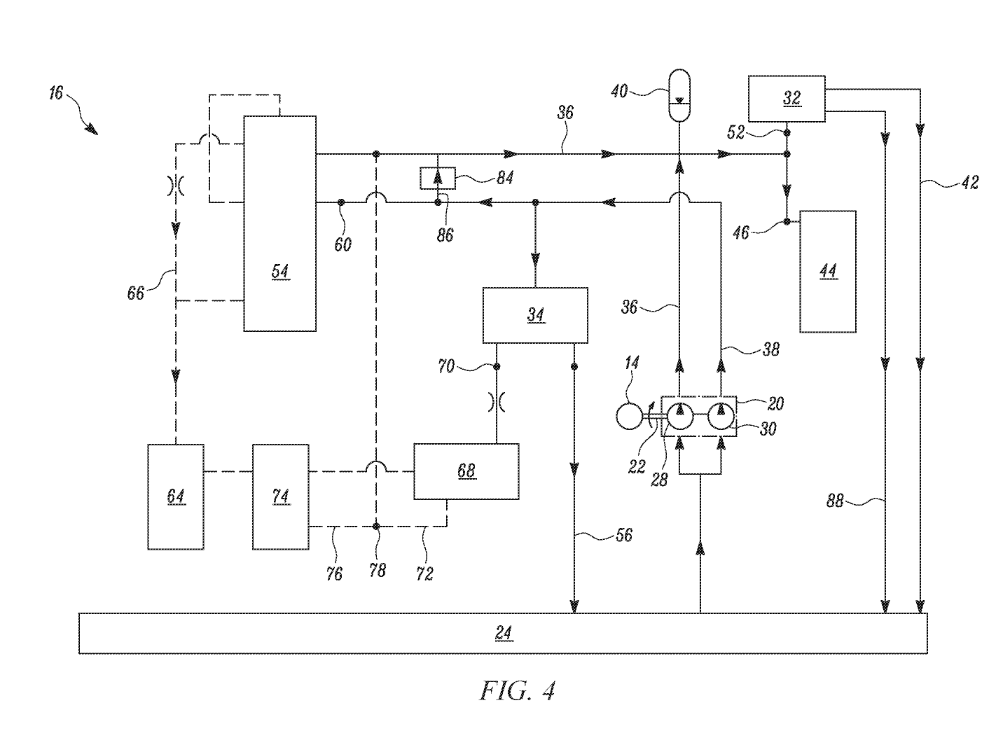

FIG. 4 is a block diagram of the hydraulic system 16 during the low engine speed condition of the machine 10 and pressure demand condition in the first supply line 36. In particular, FIG. 4 illustrates a status of the hydraulic system 16 after a time interval from the status shown in FIG. 3. As the accumulator 40 keeps supplying the pressurized fluid to the first supply line 36, the amount of fluid available in the accumulator 40, and therefore the pressure of the fluid, gradually decreases. As such, the accumulator 40 may not assist the hydraulic system 16 after the time interval to maintain the first desired pressure in the first supply line 36. Therefore, the first supply line 36 experiences a pressure drop. However, owing to the pressurized fluid received from the pump 20 and the first supply line 36, the pressure demand in the second supply line 38 is met.

As mentioned earlier, the first flow control valve 68 and the second flow control valve 74 are connected to the first supply line 36 via the first pressure sensing line 72 and the second pressure sensing line 76, respectively. Accordingly, due to the pressure reference drawn, the pressure in the first flow control valve 68 and the second flow control valve 74 also drops. Such pressure drop allows the springs deployed in the first flow control valve 68 and the second flow control valve 74 to expand, which was otherwise compressed. Owing to such expansion of the springs, the respective spools in the first flow control valve 68 and the second flow control valve 74 are pushed in a direction of expansion of the springs.

Accordingly, the movement of the spool in the first flow control valve 68 blocks the outlet 70 of the variator 34, thereby restricting flow of fluid from the variator 34 to the sump 24 when the pressure in the first supply line 36 is less than the first desired pressure. Such restriction of the flow of fluid from the variator 34 causes a back pressure to be developed within the variator 34, thereby allowing the pressurized fluid to flow towards pressure relieving valve 54. However, it should be understood that the leakage flow from the variator 34 continues to be routed to the sump 24 via the third discharge line 56. Further, the restriction of flow of fluid and the back pressure aids in development of pressure in the second supply line 38, which gradually increases beyond the second desired pressure. In order to utilize such excess pressure to meet the pressure demand in the first supply line 36, the hydraulic system 16 further includes a check valve 84 in fluid communication with the second supply line 38 via a passage 86.

The check valve 84 is actuated when the pressure of the fluid in the second supply line 38 is greater than a sum of pressure in the first supply line 36 and a biasing pressure of the check valve 84. The biasing pressure of the check valve 84 may be understood as a maximum pressure delta at which the check valve 84 opens and allows flow of pressurized fluid from the second supply line 38 to the first supply line 36. Accordingly, the first desired pressure in the first supply line 36 is achieved. The check valve 84 functions as none-way valve by allowing flow of pressurized fluid only from the second supply line 38 to the first supply line 36. Subsequently, the pressurized fluid is supplied to the clutch 32. Any leakage from the clutch 32 is routed to the sump 24 via the first discharge line 42 and the spent fluid from the clutch 32 is routed to the sump 24 via a sixth discharge line 88.

On the other hand, the movement of the spool in the second flow control valve 74 blocks flows of pilot fluid that was routed to the sump 24 via the fifth discharge line 80. As such, a back pressure develops in the pilot valve 64 due to such restriction of flow of the pilot fluid. In such situations, the pilot valve 64 sets a pilot pressure for the pressure relieving valve 54. The set pilot pressure restricts the pressure relieving valve 54 from relieving the pressure in the second supply line 38. Furthermore, when speed of the engine 14 increases or when flow demand decreases, the hydraulic system 16 switches to the normal operating condition as described with reference to FIG. 2A, 2B, or 2C.

Various embodiments disclosed herein are to be taken in the illustrative and explanatory sense, and should in no way be construed as limiting of the present disclosure.

### INDUSTRIAL APPLICABILITY

The present disclosure relates to the hydraulic system 16 for the transmission assembly 18 of the machine 10. The pressure relieving valve 54 of the hydraulic system 16 ensures adequate flow of fluid in the first supply line 36 or the second supply line 38 to maintain the first desired pressure and the second desired pressure, respectively. Additionally, during the pressure demand condition, as described with reference to FIG. 4, the first flow control valve 68 and the second flow control valve 74 blocks fluid from the variator 34, thereby causing development of back pressure in the second supply line 38. Such back pressure allows diversion of the fluid into the first supply line 36 and to the downstream components, such as the clutch 32, which require immediate fluid supply.

The first flow control valve 68 and the second flow control valve 74 prevent excessive pressure drop in the first supply line 36 and also prevent over-pressurizing of components associated with the second supply line 38. The pressure relieving valve 54 maintains pressure in the second supply line 38 by relieving fluid to the fourth discharge line 58 or by reducing flow of fluid from the first supply line 36. The check valve 84 permits flow of fluid from the second supply line 38 to the first supply line 36, which completes the bi-directional flow capability of the hydraulic system 16. Such bi-directional capability and reducing function of the pressure relieving valve 54, along with the cross-over function of the check valve 84, overcomes requirement of high volume of the accumulator 40 and large sections of the pump 20, Owing to such flexibility in deploying pump 20 of comparatively small capacity, or size of the pump 20, flow of fluid along the first supply line 36 and the second supply line 38 may be easily optimized. For example, diameter of hose and/or filters on the first and the second sections 28, 30 of the pump 20 can be reduced, wherever necessary. Accordingly, cost of the hydraulic system 16 may be decreased and constraints on available space may be overcome. Furthermore, the bi-directional capability also minimizes occurrence of failure of clutch 32 due to lack of pressurized fluid delivery, which otherwise is encountered in conventional hydraulic systems of transmission assembly 18.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic system for a transmission assembly of a machine, the transmission assembly having a clutch and a variator, the hydraulic system comprising:
a hydraulic power supply unit in fluid communication with a sump, the hydraulic power supply unit comprising:
a first section adapted to pressurize fluid to a first pressure; and
supply the pressurized fluid to the clutch via a first supply line; and
a second section adapted to pressurize the fluid to a second pressure, and supply the pressurized fluid to the variator via a second supply line, wherein the second pressure is less than the first pressure;
at least one accumulator in fluid communication with the first supply line, the at least one accumulator adapted to receive fluid from the first supply line, store the fluid at a predetermined accumulator pressure, and supply the pressurized fluid to the clutch via the first supply line, when a pressure of the fluid in the first supply line is less than a first desired pressure of the first supply line;
a pressure relieving valve in fluid communication with the first supply line and the second supply line, the pressure relieving valve adapted to:
maintain the first desired pressure in the first supply line by routing the pressurized fluid from the second supply line to the first supply line when a pressure of the fluid in the accumulator is less than the predetermined accumulator pressure; and
maintain a second desired pressure in the second supply line by routing the pressurized fluid from the first supply line to the second supply line when a pressure of the fluid in the second supply line is less than the second desired pressured; and
route fluid from at least one of the first supply line and the second supply line to the sump, until the first desired pressure and the second desired pressure in the first supply line and the second supply line, respectively, is achieved;
a first flow control valve in fluid communication with an outlet of the variator, wherein the first flow control valve is adapted to allow flow of the fluid from the variator to the sump, and wherein the first flow control valve is coupled to the first supply line via a first pressure sensing line to draw a pressure reference from the first supply line;
a second flow control valve in fluid communication with the pressure relieving valve via a second pressure sensing line to draw a pressure reference from the pressure relieving valve, and in fluid communication with the first supply line via a third pressure sensing line to draw a pressure reference from the first supply line,
wherein the second flow control valve routes the fluid received from the pressure relieving valve to the sump when the first desired pressure in the first supply line is achieved, and
wherein the first flow control valve restricts flow of fluid from the variator to the sump when the pressure in the first supply line is less than the first desired pressure, and wherein the restriction allows the fluid to flow towards the pressure relieving valve for being supplied to the first supply line to achieve the first desired pressure in the first supply line.
